(19) United States
(12) Patent Application Publication
(10) Pub. No.: US 2024/0001313 A1
(43) Pub. Date: Jan. 4, 2024

(54) CARBONATOR OF USER-FRIENDLY DESIGN AND METHOD OF CARBONATING A BEVERAGE

(71) Applicant: AARKE AB, Stockholm (SE)

(72) Inventors: Melker MAGNERIUS, Stockholm (SE); Jonas GROTH, Enskede (SE); Gustav SOLBERGER, Stockholm (SE)

(21) Appl. No.: 18/252,328

(22) PCT Filed: Nov. 10, 2021
(86) PCT No.: PCT/EP2021/081212

§ 371 Date: May 9, 2023

(30) Foreign Application Priority Data
Nov. 11, 2020 (SE) 2051315-6

(51) Int. Cl. B01F 23/2361; B01F 23/236; B01F 35/60

(52) U.S. Cl. CPC B01F 23/2361; B01F 23/2364; B01F 35/602; B01F 35/6052

(57) ABSTRACT

A carbonator for carbonating a beverage in a beverage container. The carbonator comprises a carbonating head with a dissolver nozzle for introducing carbonating medium into the beverage container, a support part for movably supporting the carbonating head between a vertically highest position and a vertically lowest position, a locking mechanism operable between an unlocked state and a locked state in which the carbonating head is retained in the vertically lowest position and a base part connected to the support part and comprising a beverage container stand for the beverage container. The locking mechanism comprises a first locking member arranged on the carbonating head and a second locking member arranged on the base part. A method of carbonating a beverage is also described.

### TECHNICAL FIELD

The present disclosure generally pertains to carbonators for carbonating beverages, and more particularly to a safe carbonator of user-friendly design. In addition, the disclosure relates to a method of carbonating a beverage.

### BACKGROUND ART

Carbonators are used for producing carbonated beverage, such as carbonated water. Carbonators for domestic use are typically designed to be placed free-standing on a table or kitchen countertop and are operated manually by a person. Such a carbonator, also known as a soda water machine, typically comprises a carbon dioxide cylinder that is connected to a nozzle that is inserted into a beverage bottle containing liquid. The carbonator further comprises an operating arrangement that allows the user to open a valve in the carbon dioxide cylinder to introduce carbon dioxide into the beverage bottle. The carbon dioxide dissolves in the liquid in the pressurised beverage bottle.

The known carbonators are marred with various drawbacks and problems such as complicated and time-consuming handling thereof, and insufficient protection should the beverage bottle break during carbonation.

For example, the prior art document EP1642637A1 discloses a carbonator that requires the user to insert a beverage bottle in a receiving flask, manually pivot the receiving flask into alignment with a filling head, move the filling head down into contact with the receiving flask while holding the receiving flask, and manually interlock the filling head and the receiving flask.

The carbonator of the document U.S. Pat. No. 4,342,710A is provided with a bursting protection that is maintained in its protecting position by a single resilient tongue, located at the upper half of the bursting protection.

U.S. Pat. No. 4,323,090A requires a movable front part being elevated and then lowered for receiving a bottle. The carbonation process involves both pulling a control arm outwardly, and sliding the arm sideways. The movable front part, which includes a safety shroud, is locked in its protecting position by pulling the control arm.

### SUMMARY OF THE INVENTION

One object of the present disclosure is to provide a free-standing carbonator of the above mentioned type that is particularly easy to use. A person operating the carbonator shall be able to quickly prepare the carbonator for receiving a beverage container and attach a beverage container using one hand only. Furthermore, the person shall be able to carbonate the beverage and also release the beverage container from the carbonator using one hand only. The entire operation of the carbonator shall allow one-hand use and require little strength and skill.

A further object is to provide a safe carbonator that protects the user from ejected liquid and fragments of the container in the event of the container breaking during carbonation. The carbonator shall further hinder the release of the beverage container when there is an internal overpressure within the container. The carbonator shall be able to accommodate a beverage container of a volume greater than 0.33 litres, such as 0.7 litres.

Such a carbonator is according to the present disclosure provided in form of a carbonator with a carbonating head having a dissolver nozzle for introducing carbonating medium into the beverage container, a support part for movably supporting the carbonating head between a vertically highest and a vertically lowest position, a locking mechanism operable between an unlocked and a locked state in which the carbonating head is retained in the vertically lowest position. The carbonator is configured such that movement of the carbonating head to the vertically lowest position sets the locking mechanism in the locked state. The carbonator comprises a base part connected to the support part and a beverage container stand for the beverage container. The locking mechanism comprises a first locking member that is arranged on the carbonating head and a second locking member that is arranged on the base part.

The carbonator of the present disclosure is easy to use. The beverage container may be conveniently placed on the beverage container stand where after the carbonating head is moved to the vertically lowest position, automatically being locked by the locking mechanism. Should a beverage container bust as a result of the internal pressure during a carbonating pressure, the resulting forces are absorbed by the carbonating head, the base part and the locking mechanism. Even forces resulting from a bursting beverage container larger than 0.33 litres may be absorbed.

Such a carbonating head may advantageously provide a compartment substantially enclosing the beverage container from above. The compartment may have an essentially closed top wall and essentially closed sides. The bottom of the compartment may be formed by the beverage container stand. Thus, a joint of the compartment will be located at a lower part of the beverage container.

The carbonator may comprise biasing means that bias the carbonating head towards the vertically highest position.

The carbonator may be configured such that said movement of the carbonating head to the vertically lowest position activates the locking mechanism and sets the locking mechanism in the locked state. More precisely, the first and/or second locking member may be activated by said movement. The carbonator may comprise guide means for translating said movement of the carbonating head into a movement of the first and/or second locking member to set the locking mechanism in the locked state. The guide means may translate an essentially vertical movement of the carbonating head into an essentially horizontal movement of the first and/or second locking member, such as a rotative movement of the first and/or second locking member.

The carbonator may comprise a venting valve arrangement for relieving an overpressure within the bottle. The carbonator is may be configured to successively open and close the venting valve arrangement when the locking mechanism is set from the unlocked state to the locked state. Thereby each time the carbonating head is brought to the vertically lowest position, the venting valve arrangement is exercised.

The carbonator may comprise biasing means that bias the venting valve arrangement towards the closed state.

The carbonator may comprise a release manipulator operable between a vertically highest position and a vertically lowest position, wherein the carbonator is configured such that movement of the release manipulator from the vertically highest position to the vertically lowest position successively opens the venting valve arrangement and sets the locking mechanism from the locked state to the unlocked state. Such a release manipulator is manoeuvrable using one hand only, and ensures that the venting valve arrangement is opened before the locking mechanism is unlocked.

The carbonator may comprise biasing means that bias the release manipulator towards the vertically highest position.

The locking mechanism may be configured such that the first and second locking members may engage in a form-fit manner. Such a locking mechanism is secure and can withstand high forces resulting from a possible bursting beverage container.

The locking mechanism may comprise translation means that translate an essentially vertical movement into an essentially horizontal movement. Such translation means may realize a form-fit in the locked state.

The first locking member may be rotatably journalled on the carbonating head. A rotatably journalled locking member may be securely locked to another member, e.g. in a form-fit lock. A rotatably engaged form-fit lock may involve large cooperating locking surfaces. The first locking member may be locked to the second locking member as a result of the carbonating head being moved to the vertically lowest position and a rotative movement of the first locking member caused by the movement of the carbonating head. The carbonator may comprise biasing means that bias the first locking member towards the locking position.

The second locking member may comprise guide means for translating a translatory movement of the carbonating head into a rotative movement of the first locking member when the carbonating head is moved to from the vertically highest position to the vertically lowest position. Such a locking mechanisms is easy to activate by a translatory movement of the carbonating head, using one hand. The translation into a rotative movement further makes possible a secure lock between the first locking member and the second locking member, e.g. a form-fit lock. The guide means may comprise an inclined guide surface and the inclination may be chosen such that an appropriate rotative movement is achieved.

As the carbonating head is moved towards its vertically lowest position, the second locking member may first, by the guide means, rotate the first locking member against its bias. When the carbonating head reaches its vertically lowest position, the second locking member may release the first locking member whereby the first locking member is rotated by the bias into engagement with the second locking member.

The carbonator may comprise valve actuating means for actuating the venting valve arrangement, the valve actuating means may be actuated by a rotation of the first locking member. The valve actuating means may comprise an actuator cam surface the inclination of which may be selected to achieve an appropriate actuating movement, e.g. a translatory actuating movement. The valve actuating means may comprise a pivoting valve actuator to amplify the actuating movement, and/or to change direction of the actuating movement. A rod actuator may be provided to transfer a translatory movement from the lower part of the carbonating head to an upper part thereof. The venting valve arrangement may advantageously be positioned at an upper end of the carbonating head.

The movement of the carbonating head from the vertically highest position to the vertically lowest position may actuate the venting valve arrangement and effect locking of the carbonating head to the base part. Such a carbonator is easy to use and involves venting valve exercise that may hinder valve clogging.

The carbonator may comprise a release member that is rotatably journalled on the carbonating head, wherein the release member and the first locking member may comprise abutment means for causing the release member to rotate along with the first locking member when the carbonating head is moved to from the vertically highest position to the vertically lowest position. By having both the first locking member and a release member rotatably journalled on the carbonating head, the release member may easily be activated by the first locking member and by other means, such as a release manipulator. The carbonator may be configured such that the release member actuates the venting valve arrangement.

The carbonator may comprise a release manipulator that is operable between a vertically highest position and a vertically lowest position, wherein the carbonator is configured such that translatory movement of the release manipulator from the vertically highest position to the vertically lowest position causes a rotative movement of the first locking member. In this way, the distance of operation of the release manipulator and the corresponding rotative movement may be chosen as appropriate. For example, a relatively long distance of operation of the release manipulator may by selected to obtain a high torque rotative movement. The carbonator may be configured such that the release member actuates the venting valve arrangement.

The release manipulator may be provided as a sliding lever protruding from a lateral side of the carbonating head. Such a release manipulator may have a long distance of operation, and is easily accessible. The distance of operation, i.e. the distance travelled by the sliding lever from its vertically highest position to its vertically lowest position, may be 3 to 10 cm, preferably 3 to 6 cm.

Movement of the release manipulator from the vertically highest position to the vertically lowest position may cause a rotative movement of the release member. In this way, an appropriate movement of the release member may be obtained. A translatory movement of the release manipulator may be converted into a customisable rotative movement of the release member.

The abutment means may be adapted to cause the first locking member to rotate along with the release member when the release member is caused to rotate by the release manipulator. The release member may thus both actuate the venting valve arrangement and unlock the first locking member from the second locking member.

The abutment means may be configured such that the first locking member rotates along with the release member after a predetermined rotation of the release member. The predetermined rotation may correspond to the rotation caused by the release manipulator being moved essentially halfway from its vertically highest position towards its vertically lowest position. The release member may then first actuate the venting valve arrangement and subsequently, after a continued rotation, unlock the first locking member from the second locking member.

The carbonator may comprise biasing means that bias the release manipulator towards a position in which the venting valve arrangement is closed. The bias of the release manipulator may, via the abutment means, bias the first locking member towards the locking position.

The carbonator may be designed such that the lowermost part of the carbonating head, when in the vertically highest position, is arranged at such a height that the beverage container may effortlessly be introduced there below. Preferably at such a height that the beverage container may be introduced below the carbonating head without tilting the beverage container more than a few degrees.

The stroke of the carbonating head, i.e. the distance travelled by the carbonating head from its vertically highest position to its vertically lowest position, may approximately equal the length of the beverage container for use with the carbonator. In this way, a compartment of the carbonating head may protectively surround essentially the whole beverage container when the carbonating head is in the vertically lowest position, while the beverage container is easily accessible when the when the carbonating head is in the vertically highest position. The stroke may correspond to at least 80% or even to at least the entire beverage container length.

The release member may comprises a release cam surface for translating the movement of the release manipulator from the vertically highest position to the vertically lowest position into a rotative movement of the release member. The movement of the release manipulator from the vertically highest position to the vertically lowest position may be a translatory movement, such as a linear movement, in particular a straight movement.

The release member may comprise an actuator cam surface for translating the rotative movement of the release member into a translatory movement, such as a linear movement, in particular a straight movement, for actuating the valve arrangement. The translatory movement may be a movement of the valve actuating means.

The venting valve arrangement may comprise two venting valves fluidly connected in parallel, thereby reducing the likelihood of venting valve failure. Preferably, the venting valve arrangement comprises a first venting valve configured to open at a first predetermined pressure and a second venting valve configured to open at a second predetermined pressure that is higher than the first predetermined pressure. The first predetermined pressure may e.g. be 5 to 7 bar. The second predetermined pressure may e.g. be 8 to 10 bar.

The first venting valve may open and emit a sound when a carbonation has been completed by introduction of carbonating medium into the beverage container. The second venting valve may function as a safety valve. The valve actuating means may be configured to actuate both the first and the second venting valves simultaneously.

The present disclosure further provides a method of carbonating a beverage comprising the steps of placing (A) a beverage container in a carbonator, locking (B) a carbonating head of the carbonator in a vertically lower position by moving the carbonating head from a vertically higher position to a vertically lower position, introducing (C) carbonating medium into the beverage container by moving a pressurizing manipulator from a vertically higher position to a vertically lower position, and unlocking (D) the carbonating head by moving a release manipulator from a vertically higher position to a vertically lower position, and relieving the pressure within the beverage container by the same movement of the release manipulator.

The step of locking (B) the carbonating head in the vertically lower position by moving the carbonating head from the vertically higher position to the vertically lower position may set a venting valve arrangement of the carbonator in the open state and in the closed state in succession, thereby exercising the venting valve arrangement.

### BRIEF DESCRIPTION OF THE DRAWINGS

The present invention will be described further below by way of example and with reference to the enclosed drawings, in which:

FIG. 1 is a side view of a carbonator 1 with a carbonating head 3, a support part 4 and a base part 6,

FIG. 2 corresponds to FIG. 1 but with a carbonating head housing and a base part housing removed,

FIGS. 3a-3b are front views corresponding to FIG. 2 with the carbonating head 3 in a vertically highest and lowest position, respectively, and also illustrate a method A-D of operating a carbonator,

FIG. 4 is a perspective view of the carbonator 1 of FIG. 2 with the carbonating head 3 positioned in-between the vertically highest position and the vertically lowest position, and

FIGS. 5a-5c are exploded views illustrating interaction of components of the carbonator 1 of FIG. 1.

### DETAILED DESCRIPTION OF EMBODIMENTS

Embodiments of the present disclosure will now be described more fully hereinafter with reference to the accompanying figures. Like reference numbers refer to like elements throughout the description and figures.

In the figures is shown a carbonator 1 with a carbonating head 3, a support part 4, a locking mechanism 5 and a base part 6. In some of the figures, a beverage container 2 is also illustrated.

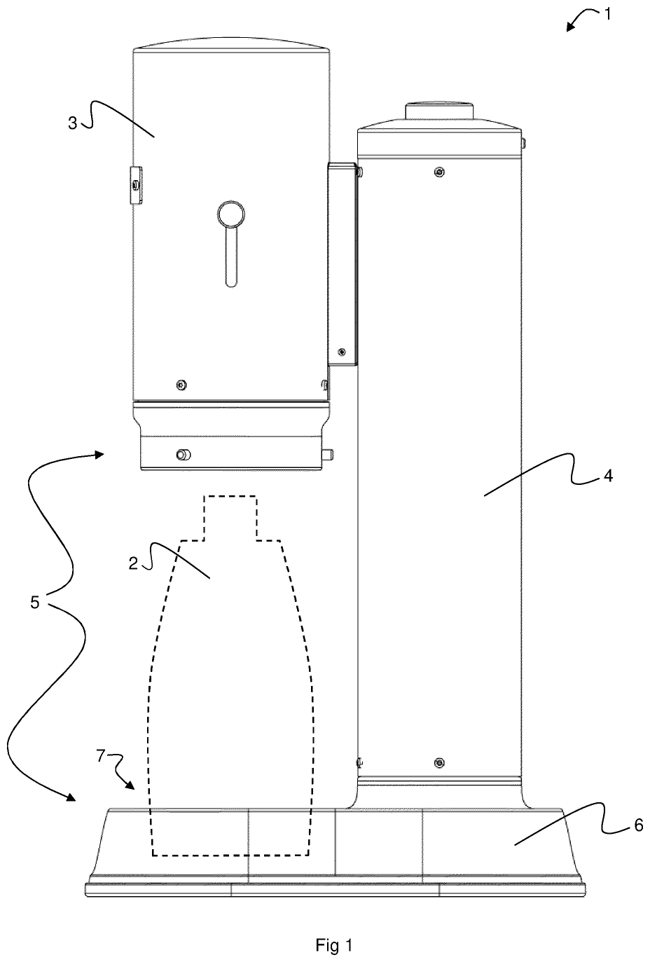

The carbonating head 3 comprises a dissolver nozzle (not shown) which during operation is immersed in liquid, typically water, contained in the beverage container 2 in form of a bottle 2. The carbonating head 3 has a generally cylindrical shape with a central longitudinal axis oriented in the vertical direction when the carbonator 1 is in operation position, see FIG. 1.

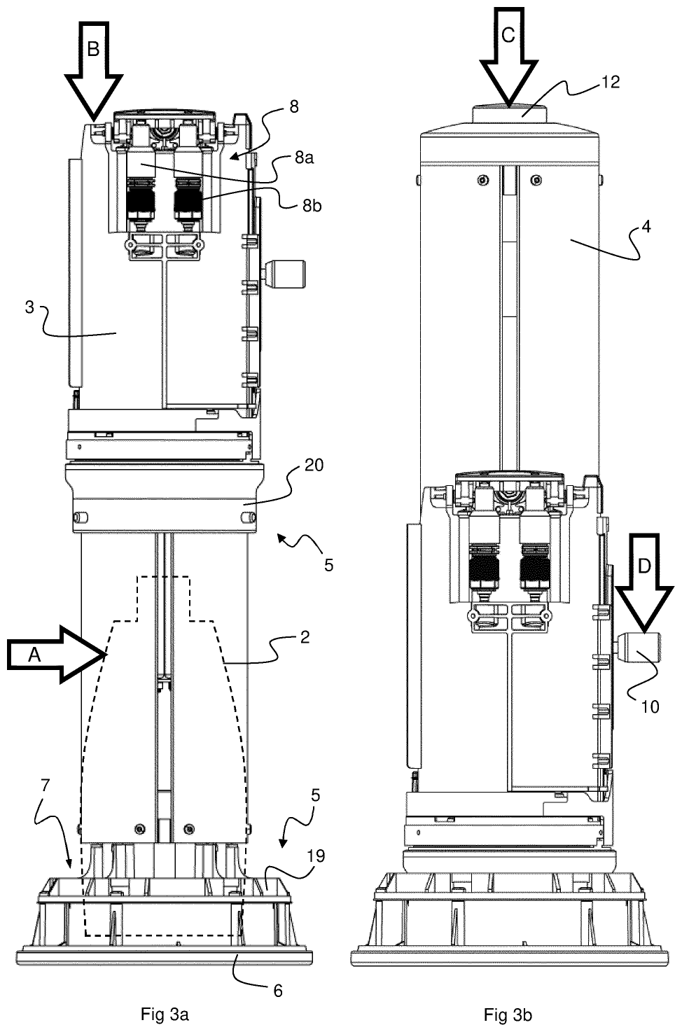

FIGS. 3a and 3b illustrate a method of operating the carbonator 1. The components and features of the carbonator 1 will be described further down below.

In a first step A, a user places the bottle 2 on a stationary and horizontal bottom of a bottle stand 7 of the base part 6. The bottle stand 7 has a bottle guiding structure that by means of gravity guides the bottle 2 to a vertical orientation straight beneath the carbonating head 3. A biasing means, e.g. including one or more springs, (not shown) within support part 4 biases the carbonating head 3 towards its vertically highest position as shown in FIG. 3a.

In a second step B, the user moves the carbonating head 3 downwards until the carbonating head 3 is locked to the bottle stand 7 of the base part 6 in its vertically lowest position, see FIG. 3b. Most conveniently, the carbonating head 3 is moved downwards by the user pushing it atop its housing by hand. The bottle 2 is now enclosed in a protecting bottle compartment. At the end of the movement, the carbonating head 3 is automatically locked to the bottle stand 7 by means of a locking mechanism 5 having cooperating locking members 20, 19 arranged on the carbonating head 3 and on the bottle stand 7, respectively.

Preferably, the second step B involves exercising a venting valve arrangement 8 by setting it in an open state and in a closed state in succession.

In a third step C, the user presses a push button 12 on the support part 4 downwards to introduce carbonating medium into the bottle 2 via the dissolver nozzle. The pressure within the bottle 2 increases and CO₂ is dissolved in the water. When the pressure inside the bottle 2 reaches a predetermined value, e.g. 5-7 bar, the venting valve arrangement 8 opens and emits a sound generated by the gas flow through the valve arrangement 8. The pressure inside the bottle 2 remains at the predetermined value and the push button 12 may be pressed repeatedly should the user desire strongly carbonated beverage.

In a fourth step D, the user moves a release manipulator 10 of the carbonating head 3 downwards until the overpressure within the bottle has been completely relieved, by the venting valve arrangement 8 opening, and subsequently the locking mechanism 5 has been unlocked. The carbonating head 3 will next be biased back to its vertically highest position (FIG. 3a) by the biasing means of the support part 4.

The method is now complete and the user may remove the bottle 2 with the carbonated liquid from the bottle stand 7.

After these method steps A-D, the carbonator 3 is ready to carbonate again without any preparation. The carbonating head 3, the release manipulator 10 and the push button 12 are all automatically returned to their respective vertically highest positions.

Importantly, all method steps A-D may be executed using one hand only. The bottle 2 is conveniently placed on and retrieved from a stationary horizontal surface provided by the bottle stand 7, the carbonating head 3, push button 12 and release manipulator 10 are all pushed downwards whereby the free-standing carbonator 1 needs not be held still.

The valve exercise that may form part of step B reduces the risk of the venting valve arrangement 8 becoming clogged. The opening of the venting valve arrangement 8 in step D to completely relieve the overpressure within the bottle 2, before unlocking the locking mechanism 5, prevents opening the compartment while there is an overpressure in the bottle 2.

The components and features of the carbonator 1 will now be described in more detail.

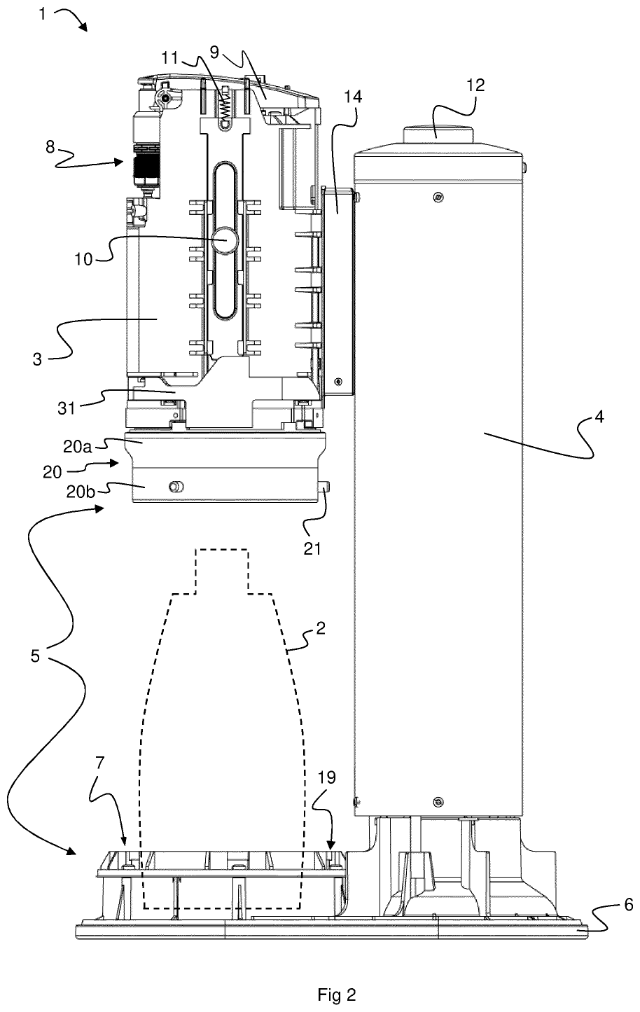

The carbonating head 3 is shown in detail in FIG. 2. The carbonating head 3 is vertically movably supported by the support part 4 between a vertically highest position and a vertically lowest position.

The carbonating head 3 is largely a thin-walled cylindrical structure and forms a recess extending from below into the structure. The recess forms the side and top of the above-mentioned compartment that is sized to enclose essentially the whole bottle 2. More precisely, the carbonating head 3 and the bottle stand 7 together form the compartment. There is a risk that the bottle 2 may break upon introduction of carbonating medium into the bottle 2 and in such an event, the compartment may effectively protect the user from ejected liquid and larger beverage container fragments. This is of particular importance should a glass bottle 2 be used.

The carbonating head 3 comprises sealing means (not shown) which are adapted to sealingly couple the mouth of the bottle 2 to the carbonating head 3 without requiring the bottle 2 being manually screwed or otherwise moved with respect to the carbonating head 3. The carbonating head 3 may conveniently be sealingly coupled to the mouth of the bottle 2 by the movement of the carbonating head 3 to its vertically lowest position. Suitable dissolver nozzles and sealing means are known per se, see for example EP1642637A1.

A sliding lever 10, which forms the release manipulator, of the carbonating head 3 protrudes out from a lateral side thereof. As most users are right handed, most users will appreciate the sliding lever 10 being positioned on the right hand side. The sliding lever is located essentially vertically centrally on the carbonating head 3. The sliding lever is conveniently used both to relieve the pressure within the bottle 2 by opening the venting valve arrangement 8 and to subsequently unlock the locking mechanism 5.

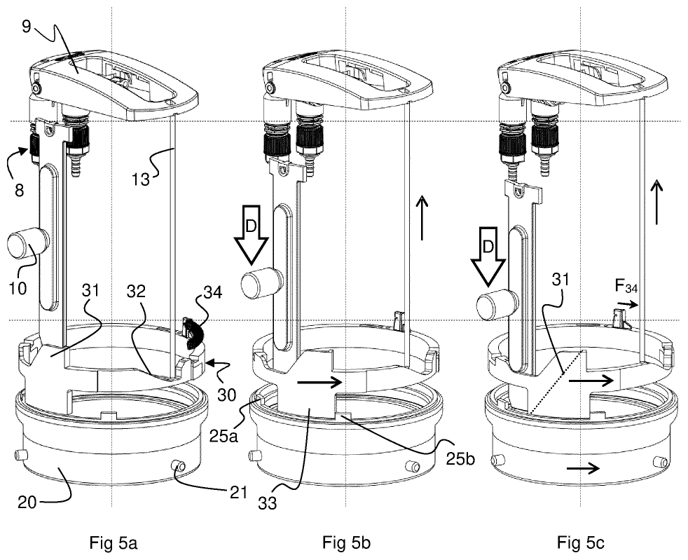

The sliding lever 10 travels in a vertical track provided in the carbonating head 3. The sliding lever 10 may be biased towards the vertically highest position by means of a sliding lever tension spring 11. The sliding lever tension spring 11 is however optional, as the sliding lever 10 is biased towards is vertically highest position by the locking sleeve return spring 34, as is described below with reference to FIG. 5a.

The venting valve arrangement 8 of the present embodiment comprises two venting valves 8a, 8b (see FIG. 3a) fluidly connected in parallel. Should a user fill too much liquid in the bottle 2, upon carbonation some of the excess liquid may be transferred via the dissolver nozzle to the venting valve arrangement 8 and be ejected therefrom. Should a user carbonate other liquids than water, such liquids may clog the valve arrangement 8 after a period of use. The provision of two venting valves 8a, 8b in parallel reduces the risk of venting valve malfunction. Furthermore, the dual venting valves 8a, 8b reduce the time needed to completely relieve the overpressure within the bottle 2 by the sliding lever 10.

A first venting valve 8a is set to open at a first pressure of e.g. 5-7 bar and emit a sound as has been described above. A second venting valve 8b is set to open at a second pressure that is higher than the first pressure, e.g. 8-10 bar. The second venting valve 8b may thus be referred to as a safety valve. The venting valve arrangement 8 of the carbonating head 3 is operable between a closed state and an open state. Each venting valve 8a, 8b of the valve arrangement 8 is furnished with a compression spring biasing the valve 8a, 8b towards the closed state. In the open state of the venting valve arrangement 8, the bottle 2 is in fluid connection with the surrounding. More precisely the upper part, not filled with liquid, of the bottle 2 is in fluid connection with the surrounding.

The venting valve arrangement 8 is advantageously positioned to eject any liquid onto the upper part of the bottle 2. Thereby the user is informed of the inappropriate over-filling of the bottle 2.

The two venting valves 8a, 8b are in the present embodiment actuated by a single pivoting valve actuator 9 located at the top of the carbonating head 3. The pivoting valve actuator 9 is pivotally journalled on the carbonating head 3 by means of a hinge connection. A vertically movable rod actuator 13 is arranged to actuate the pivoting valve actuator 9, as is shown in FIGS. 5a to 5c. The rod actuator 13 is in turn actuated by the locking mechanism 5.

Thus, both venting valves 8a, 8b are opened and closed (exercised) when the carbonating head 3 is moved downwards until being 3 locked to the bottle stand 7 by the locking mechanism 5 (step B). More precisely, the venting valves 8a, 8b are exercised at the end of the stroke of the carbonating head, i.e. when the bottle stand 7 rotates the locking sleeve as is described below. After the push button 12 has been depressed to carbonate the water, only the first venting valve 8a will open and signal to the user that a carbonation has been completed (step C). During carbonation, the second valve 8b is a redundant valve (safety valve). Both venting valves 8a, 8b are opened when the sliding lever 10 is moved downwards to relieve the overpressure within the bottle 2 and unlock the carbonating head from the bottle stand 7.

Returning to FIG. 2, the support part 4 is largely a hollow cylindrical structure receiving a CO₂ cylinder (not shown) that provides carbon dioxide to the dissolver nozzle of the carbonating head 3. At the top, the support part 4 is furnished with a pressurizing manipulator 12, which may be referred to as a push button 12, operable by a user between a vertically highest position and a vertically lowest position. The pressurizing manipulator 12 is biased towards the vertically highest position by means of the pressure within the CO₂ cylinder, a spring within the CO₂ cylinder, and/or additional biasing means (not shown).

The carbonating head 3 is carried by the support part 4 by means of a carrier unit 14. The support part 4 supports the carbonating head 3 such that it is translatory movable, more precisely linearly movable, from its vertically highest position to its vertically lowest position. A biasing means, such as one or more springs, (not shown) of the support part 4 biases the carrier unit 14 and thus the carbonating head 3 towards the vertically highest position.

The base part 6 essentially comprises two sections, a first section (left in FIG. 1) with the bottle stand 7 and a second section (right in FIG. 1) that forms a foundation for the support part 4. The base part 6 provides a stable basis for the support part 4 and thus the carbonating head 3. The base part 6 is adapted to be placed on a flat surface such as a table or a kitchen countertop and may comprise rubberised feet or similar.

FIG. 2 illustrates a bottle 2 placed on the bottle stand 7 of the base part 6. The bottle stand 7 generally has the shape of a circular trough, a standing closed-bottom cylinder with a diameter greater than the height.

The locking mechanism 5 comprises members arranged on the carbonating head 3 and on the base part 6, respectively, which engage in a bayonet-fitting manner when in the locked state.

The carbonating head 3 comprises a first locking member in form of a locking sleeve 20 that is rotatably journalled on the lower end of the carbonating head 3. The locking sleeve 20 is rotatable around the central axis of the carbonating head 3, i.e. in a horizontal plane. The locking sleeve 20 comprises an upper, or proximal, portion 20a and a lower, or distal, portion 20b. The proximal portion 20a has an outer diameter that corresponds to the diameter of the carbonating head 3. The distal portion 20b has a smaller diameter and is provided with a number of, in this example three, locking protrusions 21. The locking protrusions 21 are of cylindrical form and protrude normal to distal portion 20b.

The base part 6 is configured to receive, rotate and lock the locking sleeve 20. The rotation of the locking sleeve 20 causes a vertical motion of the rod actuator 13.

In more detail, the bottle stand 7 of the base part 6 is configured to receive the distal portion 20b of the locking sleeve 20. The bottle stand 7 has a second locking member in form of a receiving structure 19. The receiving structure 19 protrudes inwards from the cylindrical wall of the bottle stand 7 and has three passages forming protrusion receivers 22. The protrusion receivers 22 are formed and positioned to receive the three locking protrusions 21.

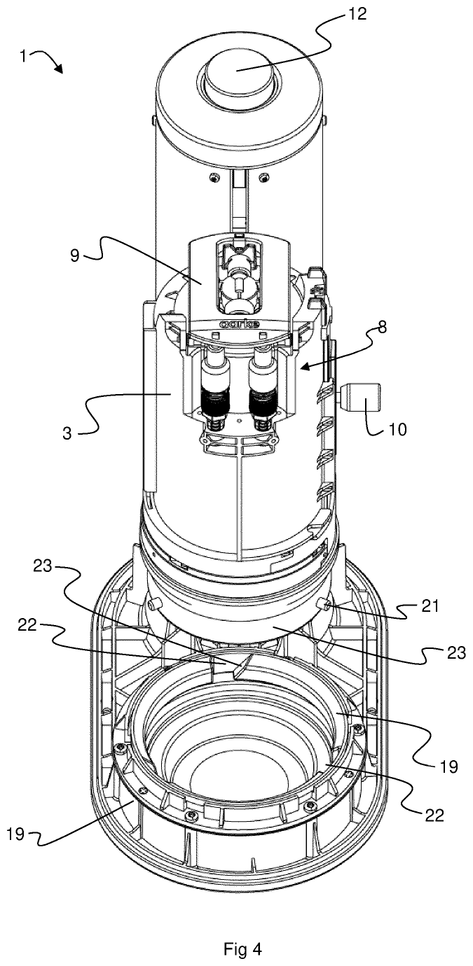

As is illustrated in FIG. 4, each protrusion receiver 22 comprises an inclined guide surface 23. As the respective locking protrusion 21 slides along the respective guide surface 23, the locking sleeve 20 is rotated counter clockwise, as seen from above. The guide surface 23 thus translates a vertical movement into a horizontal movement. When the locking protrusions 21 have travelled passed the protrusion receivers, the locking sleeve is rotated clockwise by the action of a locking sleeve return spring 34 (spring shown in FIG. 5a, spring force F₃₄ indicated in FIG. 5c). The locking protrusions 21 are now axially locked beneath the receiving structure 19. The locking sleeve 20 cooperates with the receiving structure 19 of the bottle stand 7 similar to a bayonet fitting, i.e. in a form-fitting manner.

FIGS. 5a to 5c illustrate the function of the sliding lever 10 that is used to unlock the locking sleeve 20 from the receiving structure 19. In FIG. 5a the sliding lever 10 is in its vertically highest position. In FIG. 5b, the sliding lever 10 has been pushed down halfway towards its vertically lowest position, which is shown in FIG. 5c.

The sliding lever 10 comprises sliding plate that cooperates with a release member in form of a release sleeve 30. The release sleeve 30 is rotatably journalled on the lower end of the carbonating head 3, above the locking sleeve 20. As is clear from FIGS. 1 and 2, the release sleeve 30 is covered by the carbonating head 3 housing whereas the locking sleeve 20 forms the lowermost visible part of the carbonating head 3 and adjoins the lowermost edge of its housing.

The locking sleeve 20 and the release sleeve 30 cooperate such that the venting valves 8a, 8b are opened before the locking mechanism 5 is unlocked, and such that the venting valves 8a, 8b are exercised when the locking mechanism 5 is engaged.

When the sliding lever 10 is pushed down, the lower end of the sliding plate travels along a release cam surface 31 (see FIG. 5c) of the release sleeve 30 and causes the release ring 30 to rotate counter clockwise as seen from above. The release sleeve 30 further comprises an actuator cam surface 32 (see FIG. 5a) that cooperates with the rod actuator 13. When the release sleeve 30 rotates counter clockwise, the actuator cam surface 32 causes the rod actuator 13 to move upwards.

The release cam surface 31 and the actuator cam surface 32 are configured such that the rod actuator 13 starts travelling upwards soon after the sliding lever 10 leaves its vertically highest position since the lower end of the rod actuator 13 rests against a short horizontal surface of the release sleeve 30 to the right of the actuator cam surface 32, as is clear from FIG. 5a. When the sliding lever 10 has been pushed down halfway (FIG. 5b), the rod actuator 13 has opened the venting valves 8a, 8b via the valve actuator 9. Should either one of the venting valves 8a, 8b not function properly, e.g. be clogged, a movement downwards of the sliding lever 10 is hindered. The sliding lever 10 is hindered from being moved to its vertically lowest position (FIG. 5c) before the venting valves 8a, 8b have been opened by the rod actuator 13 and the pivoting valve actuator 9. Thus, an opening of the compartment while there is an overpressure in the bottle 2 is prevented.

The release sleeve 30 comprises a first abutment means in form of an axial projection 33 that is caught between second and third axial projections 25a, 25b of the locking sleeve 20. When the sliding lever 10 has been pushed down halfway, the first axial projection 33 of the release sleeve 30 abuts against the third axial projection 25b of the locking sleeve (see FIG. 5b) and causes the locking sleeve 20 to rotate along with the release sleeve 30 counter clockwise. When the sliding lever 10 has reached its lowermost position, the locking sleeve 20 has rotated to align its locking protrusions 21 with the protrusion receives 22, and thus the locking sleeve 20 is no longer retained axially by the receiving structure 19. The carbonating head 3 can now be biased back to its vertically highest position by the biasing means of the support part 4.

When the locking sleeve 20 is rotated counter clockwise during locking the carbonating head 3 to the bottle stand 7 as described above, the second axial protrusion 25a of the locking sleeve 20 abuts against the first axial protrusion 33 of the release sleeve and causes the release sleeve 30 to rotate along with the locking sleeve 20 counter clockwise. By means of the actuator cam surface 32, the rod actuator 13 and the valve actuator 9, such rotation of the release sleeve 30 opens the venting valves 8a, 8b. When the release sleeve 30 is subsequently rotated clockwise by the locking sleeve tension spring 34 (see force F₃₄ in FIG. 5c), the venting valves 8a, 8b are again closed by the rod actuator 13 being translated upwards to pivot the valve actuator. Thus, when the carbonating head is brought down to be locked to the base part 6, the venting valves 8a, 8b are exercised by being opened and closed in succession.

When the carbonating head 3 is locked to the base part 6, the bottle stand 7 closes the compartment. As the compartment is dimensioned to enclose essentially the whole bottle 2 and is brought down over the bottle 2, the joint between the carbonating head 3 and the base bottle stand 7 is located close to the bottom of the bottle 2. Such a location of the joint may be particularly beneficial, as it is believed that the bottle 2 is more likely to break at an upper portion thereof, which upper portion is located remote from the joint. Furthermore, no matter where the bottle 2 breaks, a substantial pressure energy is stored in the upper portion of the bottle 2, where a compressive gas (air and CO₂) is located.

The carbonating head 3, release manipulator 10 and pressurizing manipulator 12 are all operable by a user from a respective vertically higher position to a respective vertically lower position. In the embodiments of this disclosure, they are all adapted to move downwards in the vertical direction during operation, more precisely straight downwards in the vertical direction. As will be appreciated, the respective movements need not be straight nor exactly vertical. The carbonator 1 may in other embodiments be configured such that at least one of the movements follows a curve and/or deviates to some extent, for example up to 20 degrees, from the vertical direction.

Importantly, though, the movements are from a vertically higher position to a vertically lower position such that one-hand use is allowed. The forces applied by a user to the carbonating head 3, to the pressurizing manipulator 12 and to the release manipulator 10 are all directed downwards whereby one-hand use is possible. Such forces press the carbonator 1 towards the surface on which it rests and thus there is no need to hold the carbonator 1 or fix it to the surface.

Throughout this disclosure, the direction “downward” is to be understood as referring to the orientation of the carbonator 1 when positioned for operation, as depicted. The arrows B, C and D, in FIGS. 3a, 3b, 5b and 5c are hence directed downward.

1. A carbonator for carbonating a beverage in a beverage container, the carbonator comprising:
a carbonating head comprising a dissolver nozzle for introducing carbonating medium into the beverage container;
a support part for movably supporting the carbonating head between a vertically highest position and a vertically lowest position;
a locking mechanism operable between an unlocked state and a locked state, wherein in the locked state the carbonating head is retained in the vertically lowest position; and
a base part connected to the support part and comprising a beverage container stand for the beverage container,
wherein the carbonator is configured such that movement of the carbonating head to the vertically lowest position sets the locking mechanism in the locked state, and wherein the locking mechanism comprises a first locking member that is arranged on the carbonating head and a second locking member that is arranged on the base part.

2-17. (canceled)

18. The carbonator of claim 1, further comprising a venting valve arrangement for relieving an overpressure within the beverage container, wherein the carbonator is configured to successively open and close the venting valve arrangement when the locking mechanism is set from the unlocked state to the locked state.

19. The carbonator of claim 1, further comprising a venting valve arrangement for relieving an overpressure within the beverage container and a release manipulator operable between a vertically highest position and a vertically lowest position, wherein the carbonator is configured such that movement of the release manipulator from the vertically highest position to the vertically lowest position successively opens the venting valve arrangement and sets the locking mechanism from the locked state to the unlocked state.

20. The carbonator of claim 1, wherein the locking mechanism is configured such that the first and second locking members are configured to engage in a form-fit manner.

21. The carbonator of claim 1, wherein the first locking member is rotatably journalled on the carbonating head.

22. The carbonator of claim 21, wherein the second locking member comprises a guide means for translating a translatory movement of the carbonating head into a rotative movement of the first locking member when the carbonating head is moved to from the vertically highest position to the vertically lowest position.

23. The carbonator of claim 21, further comprising a venting valve arrangement and a valve actuating means for actuating the venting valve arrangement, the valve actuating means being actuated by a rotation of the first locking member.

24. The carbonator of claim 23, configured such that the movement of the carbonating head from the vertically highest position to the vertically lowest position actuates the venting valve arrangement and effects locking of the carbonating head to the base part.

25. The carbonator of claim 21, further comprising a release member that is rotatably journalled on the carbonating head, wherein the release member and the first locking member comprise abutment means for causing the release member to rotate along with the first locking member when the carbonating head is moved to from the vertically highest position to the vertically lowest position.

26. The carbonator of claim 25, further comprising a release manipulator operable between a vertically highest position and a vertically lowest position, wherein the carbonator is configured such that movement of the release manipulator from the vertically highest position to the vertically lowest position causes a rotative movement of the first locking member.

27. The carbonator of claim 26, wherein the carbonator is configured such that movement of the release manipulator from the vertically highest position to the vertically lowest position causes a rotative movement of the release member.

28. The carbonator of claim 27, wherein the abutment means is adapted to cause the first locking member to rotate along with the release member when the release member is caused to rotate by the release manipulator.

29. The carbonator of claim 28, wherein the abutment means is configured such that the first locking member rotates along with the release member after a predetermined rotation of the release member.

30. The carbonator of claim 27, wherein the release member comprises a release cam surface for translating the movement of the release manipulator from the vertically highest position to the vertically lowest position into the rotative movement of the release member, and wherein the release member comprises an actuator cam surface for translating the rotative movement of the release member into a translatory movement for actuating a venting valve arrangement.

31. The carbonator of claim 18, wherein the venting valve arrangement comprises a first venting valve configured to open at a first predetermined pressure and a second venting valve configured to open at a second predetermined pressure that is higher than the first predetermined pressure.

32. A method of carbonating a beverage, the method comprising:
placing a beverage container in a carbonator;
locking a carbonating head of the carbonator in a vertically lower position by moving the carbonating head from a vertically higher position to a vertically lower position;
introducing carbonating medium into the beverage container by moving a pressurizing manipulator from a vertically higher position to a vertically lower position; and
unlocking the carbonating head by moving a release manipulator from a vertically higher position to a vertically lower position, and relieving the pressure within the beverage container by the same movement of the release manipulator.

33. The method of claim 32, wherein the step of locking the carbonating head in the vertically lower position by moving the carbonating head from the vertically higher position to the vertically lower position sets a venting valve arrangement of the carbonator in an open state and in a closed state in succession.
